(19) United States
(12) Patent Application Publication
(10) Pub. No.: US 2017/0148485 A1
(43) Pub. Date: May 25, 2017

(54) MAGNETIC DISK DEVICE AND READING METHOD

(71) Applicant: Kabushiki Kaisha Toshiba, Tokyo (JP)

(72) Inventor: Akihiro Harigae, Fujisawa Kanagawa (JP)

(21) Appl. No.: 15/052,265

(22) Filed: Feb. 24, 2016

Related U.S. Application Data
(60) Provisional application No. 62/258,042, filed on Nov. 20, 2015.

(51) Int. Cl. G11B 20/18

(52) U.S. Cl. CPC G11B 20/1816; G11B 2020/183

(57) ABSTRACT

According to one embodiment, when an access destination of a reading request is a second region, a controller performs a first retry reading process by use of a second reading condition in first parameter information. The second region is adjacent to a first region, which is adjacent to a defect region and has a particular width, and is present as a region other than the defect region on a magnetic disk. When the access destination of the reading request is the first region, the controller performs a second retry reading process by use of a fourth reading condition in second parameter information. The second parameter information is set such that a grown defect is registered at an earlier time in the second retry reading process, as compared with that in the first retry reading process.

### CROSS-REFERENCE TO RELATED APPLICATIONS

This application is based upon and claims the benefit of priority from U.S. Provisional Application No. 62/258,042, filed on Nov. 20, 2015; the entire contents of which are incorporated herein by reference.

### FIELD

Embodiments described herein relate generally to a magnetic disk device and a reading method.

### BACKGROUND

In general, a primary defect and a grown defect are present in a recording medium of a magnetic disk device. The primary defect is a defect generated when the magnetic disk device is manufactured, and the grown defect is a defect generated after the magnetic disk device is shipped, i.e., in a use stage of the magnetic disk device by a user. As a factor of the primary defect and the grown defect, there may be a medium flaw. The medium flaw may grow to a degree with which the medium flaw affects a region adjacent to a primary defect or a grown defect. A portion in this state can be a grown defect in the long term, and so the long term reliability is lowered.

### BRIEF DESCRIPTION OF THE DRAWINGS

FIG. 1 is a block diagram schematically showing an overview configuration example of a magnetic disk device according to a first embodiment;

FIG. 2 is a view showing an example of primary defect position information;

FIG. 3 is a view showing an example of first parameter information according to the first embodiment;

FIG. 4 is a view showing an example of grown defect position information;

FIG. 5 is a view showing an example of address conversion information;

FIG. 6 is a view showing an example of caution region address information according to the first embodiment;

FIG. 7 is a view showing an example of second parameter information according to the first embodiment;

FIG. 8 is a flow chart showing an example of a sequence of a caution region registration process according to the first embodiment;

FIG. 9 is a flow chart showing an example of a sequence of a reading process according to the first embodiment;

FIGS. 10A and 10B are views respectively showing examples of a re-reading process and a data relief process;

FIG. 11 is a view showing an example of caution region address information according to a second embodiment; and

FIG. 12 is a flow chart showing an example of a sequence of a caution region registration process according to the second embodiment.

### DETAILED DESCRIPTION

In general, according to one embodiment, a magnetic disk device includes a magnetic disk that stores data, and a controller. The magnetic disk is provided with a recording surface. The recording surface includes a defect region including a defect portion on the recording surface, a first region adjacent to the defect region and having a particular width, and a second region adjacent to the first region and present as a region other than the defect region. The controller is configured to perform writing of data into the magnetic disk and reading of data from the magnetic disk. When an access destination of a reading request is the second region, the controller performs a reading process by use of a first reading condition for a normal reading in first parameter information, and, if reading of data fails, the controller performs a first retry reading process by use of a second reading condition, which is a setting condition for retry reading, in the first parameter information. The first parameter information includes the first reading condition and a plurality of different second reading conditions. When the access destination of the reading request is the first region, the controller performs a reading process by use of a third reading condition for a normal reading in second parameter information, and, if reading of data fails, the controller performs a second retry reading process by use of a fourth reading condition, which is a setting condition for retry reading, in the second parameter information. The second parameter information includes the third reading condition and a plurality of different fourth reading conditions. If reading of the data fails in the first retry reading process even by performing retry reading a first number of times, the controller registers a writing position of the data in the second region as a grown defect. If reading of the data fails in the second retry reading process even by performing retry reading a second number of times, the controller registers a writing position of the data in the first region as a grown defect. The second parameter information is set such that the grown defect is registered at an earlier time in the second retry reading process, as compared with that in the first retry reading process.

Exemplary embodiments of a magnetic disk device and a reading method will be explained below in detail with reference to the accompanying drawings. The present invention is not limited to the following embodiments.

### First Embodiment

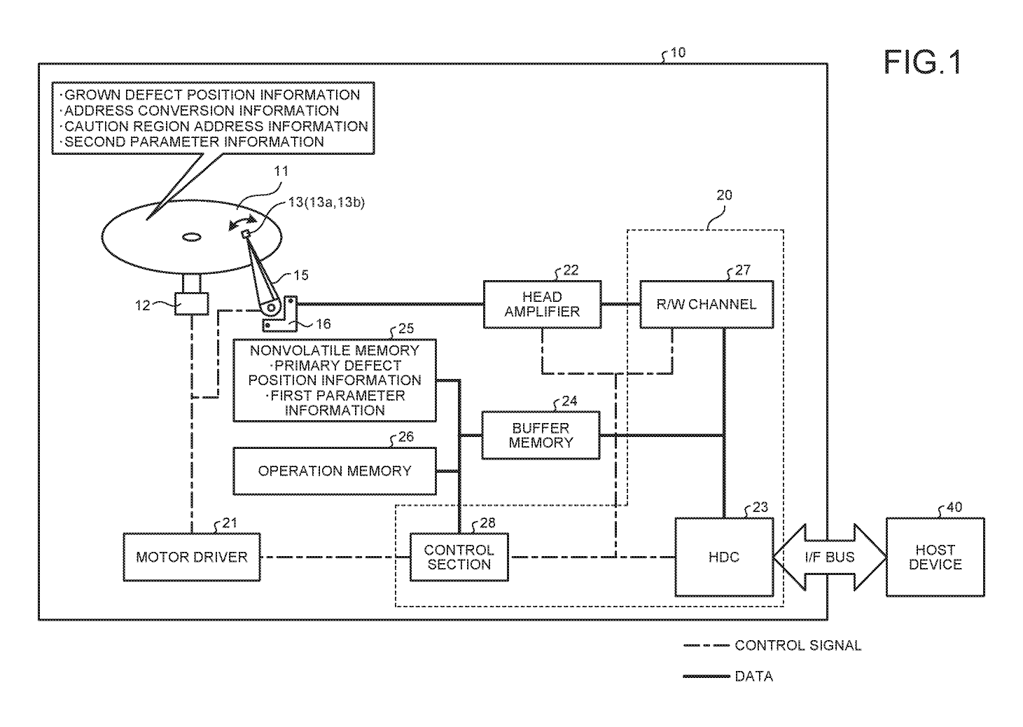

FIG. 1 is a block diagram schematically showing an overview configuration example of a magnetic disk device according to a first embodiment. The magnetic disk device 10 may be exemplified by a Hard Disk Drive or the like. For example, the Hard Disk Drive is configured to record information into a magnetic disk 11 via a magnetic head 13, and to read information from the magnetic disk 11 via the magnetic head 13.

The magnetic disk device 10 includes the magnetic disk 11, a spindle motor 12, the magnetic head 13, an actuator arm 15, a voice coil motor (which will be referred to as VCM, hereinafter) 16, a motor driver 21, a head amplifier 22, a hard disk controller (which will be referred to as HDC, hereinafter) 23, a buffer memory 24, a nonvolatile memory 25, an operation memory 26, a reading/writing channel (which will be referred to as R/W channel, hereinafter) 27, and a control section 28.

The magnetic disk 11 has a recording surface for recording data. The recording surface includes a plurality of tracks each having a predetermined width in the radial direction. Each of the tracks includes a plurality of data sectors in the circumferential direction. If there are a plurality of magnetic disks 11, the magnetic head 13 is equipped with each of the recording surfaces respectively. The magnetic disk 11 can be rotated at a predetermined rotation number about a rotation axis by the spindle motor 12. The spindle motor 12 is driven to rotate by an electric current (or voltage) supplied from the motor driver 21.

The magnetic head 13 includes a writing head 13a and a reading head 13b. The writing head 13a is used to write data into the magnetic disk 11, and the reading head 13b is used to read data from the magnetic disk 11. Further, the magnetic head 13 is attached to a distal end of the actuator arm 15, and can be moved by the VCM 16 in the radial direction (cross-track direction) of the magnetic disk 11. The VCM 16 is driven by an electric current (or voltage) supplied from the motor driver 21.

The motor driver 21 supplies the spindle motor 12 with an electric current or voltage, to drive the spindle motor 12 at a predetermined rotational number. Further, the motor driver 21 supplies the VCM 16 with an electric current or voltage instructed by the control section 28, to drive the actuator arm 15.

The head amplifier 22 is configured to amplify a signal read by the magnetic head 13 (reading head 13b) from the magnetic disk 11, and to output and supply it to the R/W channel 27. Further, the head amplifier 22 is configured to supply the magnetic head 13 (writing head 13a) with a signal supplied from the R/W channel 27, which is based on a signal for writing data into the magnetic disk 11.

The HDC 23 is configured to control transmission and reception of data performed with respect to a host device 40 via an I/F bus, and to control the buffer memory 24, and further to perform a data error correction process for read data and for write data.

The buffer memory 24 is used as a cache for data transmitted and received with respect to the host device 40. Further, the buffer memory 24 is used to temporarily store data read from the magnetic disk 11, data to be written into the magnetic disk 11, and/or control firmware read from the magnetic disk 11. As the buffer memory 24, for example, a DRAM (Dynamic Random Access Memory) or SDRAM (Synchronous Dynamic Random Access Memory) is used.

The nonvolatile memory 25 stores initial firmware, for example. The initial firmware is a program to be executed at first when the magnetic disk device 10 is activated. As the nonvolatile memory 25, for example, a Flash ROM (Flash Read Only Memory) or the like is used.

The operation memory 26 stores control firmware. The control firmware is a program used for the normal operation after the magnetic disk device 10 is activated. As the operation memory 26, for example, an SRAM (Static Random Access Memory) or the like is used.

The R/W channel 27 is configured to perform code modulation to data supplied from the HDC 23 to be written into the magnetic disk 11, and to supply it to the head amplifier 22. Further, the R/W channel 27 is configured to perform code demodulation to a signal read from the magnetic disk 11 and supplied via the head amplifier 22, and to output it as digital data to the HDC 23.

The control section 28 is the main controller of the magnetic disk device 10, and is configured to perform various processes, such as control processes for writing data and reading data by the magnetic head 13, and a servo control process for controlling the position of the magnetic head 13 above the recording surface of the magnetic disk 11, for example.

The buffer memory 24 for temporary storage, the nonvolatile memory 25, and the operation memory 26 are directly or indirectly connected to the control section 28. The control section 28 is configured to perform the overall control of the magnetic disk device 10, in accordance with firmware stored in advance in the nonvolatile memory 25 or magnetic disk 11. The firmware includes the initial firmware and the control firmware as described above. For example, the initial firmware is stored in the nonvolatile memory 25, and the control firmware is recorded in the magnetic disk 11. Under the control in accordance with the initial firmware, the control firmware is read from the magnetic disk 11 once into the buffer memory 24, and is then stored in the operation memory 26.

Here, in this embodiment, the HDC 23, the R/W channel 27, and the control section 28 are incorporated in an integrated circuit 20 called SoC (System on Chip), which is integrated into one chip. This integrated circuit 20 serves as a controller in a broad sense.

In the first embodiment, if the size of a primary defect is not smaller than a predetermined size, it is assumed that the primary defect is likely to be a continuous medium flaw and the primary defect will grow in the long term. Accordingly, a region adjacent to a primary defect not smaller than the predetermined size is regarded as a caution region, which is a first region. Then, a reading condition for a retry reading process at the caution region is set such that grown defect registration is performed at an earlier time, as compared with the normal region, which is a second region, other than the caution region. Here, there are two types of the grown defect registration. One of them is made such that, if reading of the data of a reading target region fails by a data relief process described later, only defect address information is registered into grown defect position information. The other one of them is made such that, if reading of the data of a reading target region succeeds by the data relief process, defect address information is registered into the grown defect position information, and a substituting process of storing this data into another storage region is performed. In the first embodiment, if reading of the data of a reading target within a caution region succeeds by the data relief process, the substituting process is supposed to be performed at an earlier time.

More specifically, in the magnetic disk device 10 according to the first embodiment, the nonvolatile memory 25 at least stores primary defect position information, and first parameter information used for retry reading. Further, the magnetic disk 11 at least stores grown defect position information, address conversion information, caution region address information, and second parameter information used for retry reading. The grown defect position information, the address conversion information, the caution region address information, and the second parameter information used for retry reading are stored in a management region within the magnetic disk 11, which cannot be accessed by any user. Here, it suffices if these pieces of information are stored in any one of the nonvolatile memory 25 and the magnetic disk 11.

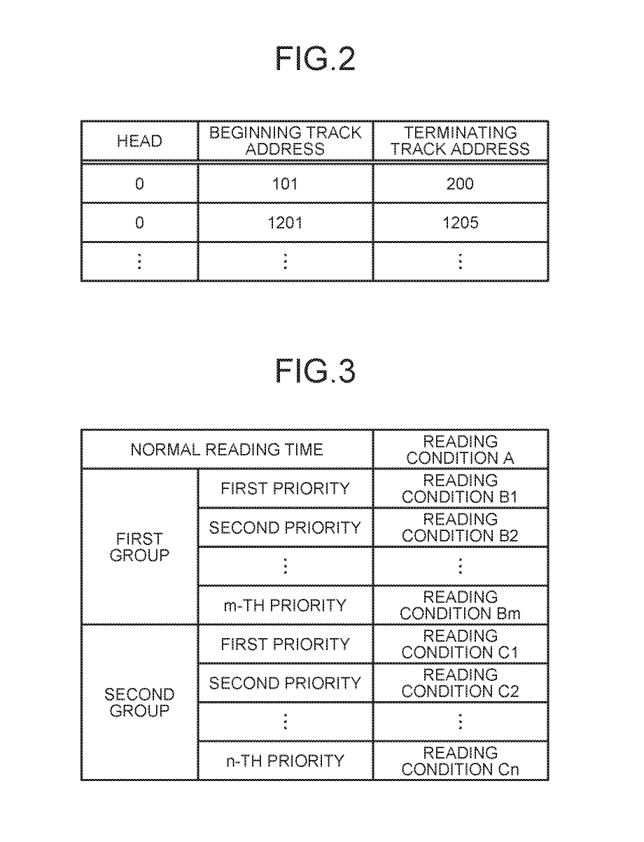

The primary defect position information includes the physical position of a primary defect on the magnetic disk 11. FIG. 2 is a view showing an example of the primary defect position information. For example, the primary defect position information includes a head corresponding to the recording surface of the magnetic disk 11 on which a primary defect is present, and the beginning track address and terminating track address of the primary defect. As each of the beginning track address and the terminating track address, a physical block address is used. The position (a data sector within a track) registered in the primary defect position information is not given any logical block address, from the beginning.

The first parameter information is information including a parameter about reading on the normal region of the magnetic disk 11 other than the caution region. The first parameter information includes reading conditions concerning a plurality of reading operations and ranked in the order of priority. This is intended to perform a retry reading process by use of different reading conditions to read data, if a reading process fails. The reading conditions include parameters concerning one or a plurality of reading operations.

FIG. 3 is a view showing an example of the first parameter information according to the first embodiment. The first parameter information is formed of a collectivity including a plurality of parameters. In this example, the parameter information is categorized into three groups composed of a normal reading time, a first group, and a second group. Here, this is a mere example, and another configuration may be used. For example, the first parameter information may be categorized into two groups composed of a first group and a second group. In this case, for the normal reading time, the reading condition of the first priority in the first group is used. The reading condition for the normal reading time is a reading condition used for a reading process performed upon reception of a read command.

The reading conditions in the first group include reading conditions used for retry reading that is to be performed if reading fails in the normal reading time. The reading conditions included in the first group are based on the premise that reading is performed to data considered as being not deteriorated in signal quality or being slightly deteriorated in signal quality, and the grown defect registration is not performed for a sector whose data reading has succeeded by use of the reading conditions in the first group. In this way, since the substituting process about a data storing position is not performed, and since the retry reading is based on the premise that reading is performed to a plurality of sectors, the reading conditions for the retry reading only include limited changes relative to the reading condition for the normal reading time.

The reading conditions in the second group include reading conditions used for retry reading that is to be performed if reading fails by the reading conditions in the first group. The reading conditions included in the second group are based on the premise that reading is performed to data considered as being deteriorated in signal quality, and are directed to a target from which data can be hardly read. Accordingly, the grown defect registration is performed, and specifically the substituting process is performed, for a sector whose data reading has succeeded by use of the reading conditions in the second group. The retry reading process using the reading conditions in the second group is performed to a specific one sector whose reading has failed, in order to avoid an error in hardware. Accordingly, the reading conditions for the retry reading include various changes relative to the reading conditions in the first group.

Each of the first group and the second group includes a plurality of reading conditions having contents different from each other, these reading conditions are ranked in the order of priority. This order of priority represents an order of being performed when a reading error is generated. For example, upon reception of a read command, a reading process is performed by use of a reading condition A for the normal reading time. If a reading error is generated in the case using the reading condition A, a retry reading process is performed by use of a reading condition B1 of the first priority in the first group. Thereafter, if a reading error is generated, the process is performed by sequentially using reading conditions until a reading condition Bm of the m-th priority (“m” is a natural number of 2 or more) in the first group. If a reading error is generated even by the case using the reading condition B in the first group, a retry reading process is then performed by use of a reading condition C1 of the first priority in the second group. Thereafter, if a reading error is generated, the process is performed by sequentially using reading conditions until a reading condition Cn of the n-th priority (“n” is a natural number of 2 or more) in the second group.

For example, a reading condition parameter may be exemplified by a track offset, which is a shift (in position) of the reading head 13b in the radial direction with respect to the target position, in positioning control. In this respect, the amplitude of the track offset is larger in the second group than in the first group, because the first group is based on the premise that reading is performed to data considered as being not deteriorated in signal quality or slightly deteriorated in signal quality, and the second group is based on the premise that reading is performed to data considered as being deteriorated in signal quality, as described above.

Further, the reading conditions included in the second group may include a parameter for applying a correction function in a concentrated manner to a sector treated as the target of a retry reading process, or a parameter of fixedly providing a sync mark position (sync mark timing) if the sync mark of a sector cannot be found.

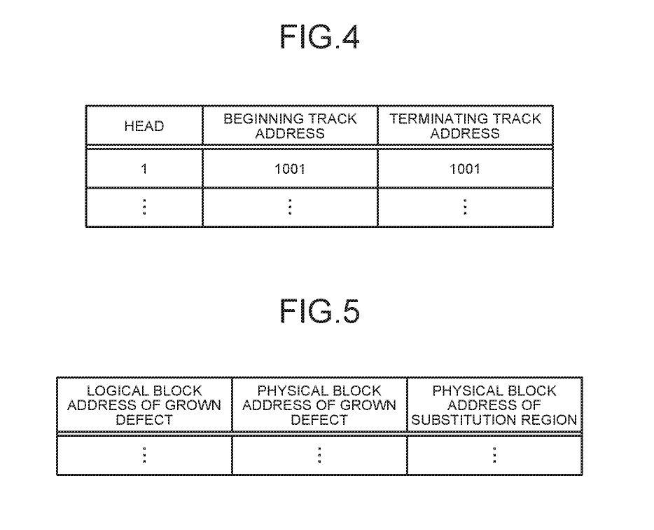

The grown defect position information includes the physical position of a grown defect on the magnetic disk 11, which is generated after the magnetic disk device 10 starts being used by a user. FIG. 4 is a view showing an example of the grown defect position information. For example, the grown defect position information includes a head corresponding to the recording surface of the magnetic disk 11 on which a grown defect is present, and the beginning track address and terminating track address of the grown defect. As each of the beginning track address and the terminating track address, a physical block address is used. Here, in this example, an address in unit of a track is used as the physical position of a grown defect, but an address in unit of a sector may be used instead.

The address conversion information is information that correlates a region including a grown defect with a substitution region. FIG. 5 is a view showing an example of the address conversion information. The address conversion information includes the logical block address and physical block address of a grown defect region and the physical block address of a substitution region. Accordingly, when access to a grown defect is requested, the address conversion information is consulted, and thereby access is made to the physical block address of a substitution region correlated with the logical block address of an access destination.

The caution region address information includes the address of the caution region adjacent to a primary defect not smaller than a predetermined size. Here, if the number of continuous tracks associated with a primary defect is not smaller than a predetermined number, a caution region is defined by a region corresponding to the predetermined number of tracks designated from the opposite ends of the primary defect. A caution region may include the maximum number of tracks in which a continuous medium flaw seems to grow during an estimated use period by a user after manufacture of the magnetic disk device 10. The estimated use period is defined by an estimated period from a time when a user starts using the magnetic disk device 10 to a time when the user discards it or stops using it. In the first embodiment, if a primary defect is a medium flaw continuous through 100 or more tracks, a caution region is set to correspond to each of the groups of ±10 tracks respectively from the opposite ends of the primary defect.

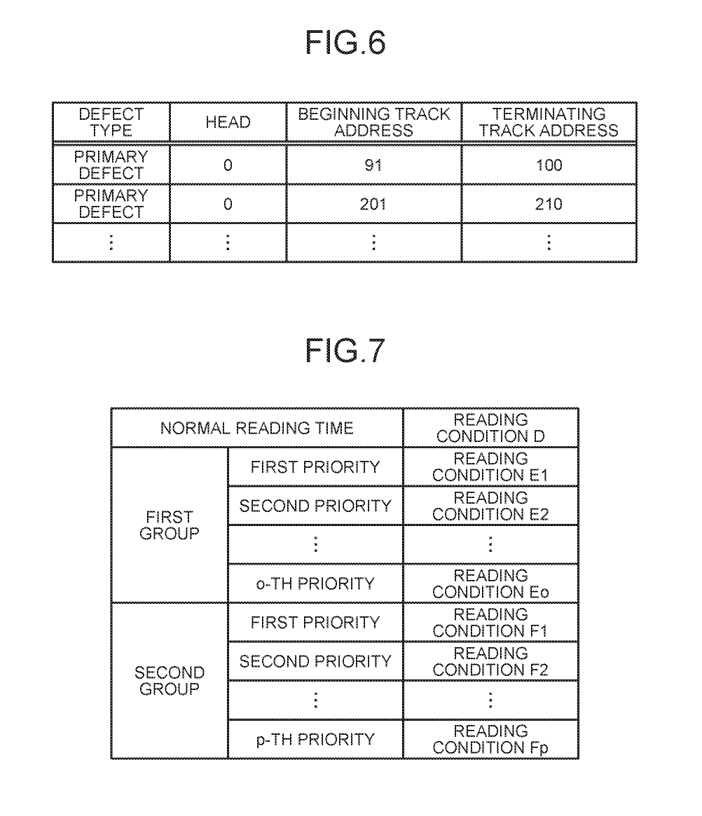

FIG. 6 is a view showing an example of the caution region address information according to the first embodiment. The caution region address information includes address information that defines a caution region adjacent to a primary defect. More specifically, it includes the type of a defect serving as a base on which a caution region is set, a head in which a primary defect is present, and the beginning track address and terminating track address of the caution region. For example, in the first record of the primary defect position information shown in FIG. 2, a primary defect is registered with a head of “0” and a track address of “101” to “200”. Since this primary defect is continued 100 or more tracks, a caution region is set. Accordingly, a caution region is stored in each of the first and second records shown in FIG. 6, to correspond to the primary defect in the first record of the primary defect position information shown in FIG. 2. The first record indicates a region corresponding to −10 tracks from the starting end of the primary defect, in which the beginning track address is at “91” in a head of “0” and the terminating track address is at “100” in the head of “0”. Further, the second record indicates a region corresponding to +10 tracks from the terminating end of the primary defect, in which the beginning track address is at “201” in the head of “0” and the terminating track address is at “210” in the head of “0”.

The second parameter information is information including a parameter about reading on a caution region of the magnetic disk 11. As in the first parameter information, the second parameter information includes a plurality of reading conditions ranked in the order of priority. FIG. 7 is a view showing an example of the second parameter information according to the first embodiment. The second parameter information has the same configuration as that of the first parameter information. More specifically, a reading condition D is registered for the normal reading time, reading conditions E1 to Eo (“o” is a natural number of 2 or more) are registered in a first group, and reading conditions F1 to Fp (“p” is a natural number of 2 or more) are registered in a second group. However, the number of reading conditions in each of the first group and the second group is different from that of the first parameter information. Specifically, in the second parameter information, the number “o” of reading conditions in the first group is expressed by o<m, and the number “p” of reading conditions in the second group is expressed by p>n. According to this arrangement, registration into the grown defect position information can be positively performed (in an early stage of the retry reading process) in the retry reading process using the second parameter information, as compared with the retry reading process using the first parameter information.

Here, in each of the first parameter information shown in FIG. 3 and the second parameter information shown in FIG. 7, reading conditions are respectively set for the normal reading time and the priorities of the first group and second group. The reading conditions are formed of parameters (setting conditions) for retry reading, and each of the reading conditions may be set with only one parameter or may be set with a plurality of parameters.

Further, the explanation described above is exemplified by a case that the second parameter information is designed to include a reduced number of reading conditions (a retry number of times) in the first group and an increased number of reading conditions (a retry number of times) in the second group, as compared with the first parameter information. However, the second parameter information may be designed to include a reduced number of parameters in each reading condition set in the first group and an increased number of parameters in each reading condition set in the second group, as compared with the first parameter information. Further, the second group of the second parameter information may be designed to include an increased number of parameters combined in each reading condition, as compared with the second group of the first parameter information.

When a reading process is performed, the control section 28 shown in FIG. 1 determines whether an access destination address is included in the caution region address information. If this address is not included, the control section 28 performs a reading process by use of the first parameter information, and, if this address is included, the control section 28 performs a reading process by use of the second parameter information. In this respect, in the manufacturing stage, the control section 28 performs a defect sorting test and generates the primary defect position information, and, at this time, it further determines whether a primary defect not smaller than a predetermined size is present by use of the primary defect position information. Then, if a primary defect not smaller than a predetermined size is present, the control section 28 designates a portion corresponding to a predetermined number of tracks from an end of this primary defect as a caution region, and registers it into the caution region address information.

Next, an explanation will be given of a caution region registration process and a reading process, performed in the magnetic disk device 10 having the structure described above.

<Caution Region Registration Process>

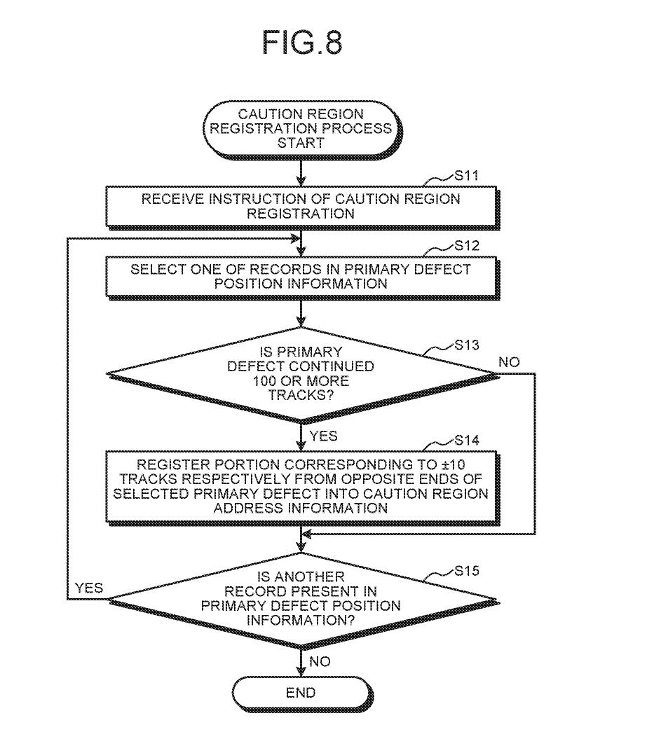

FIG. 8 is a flow chart showing an example of a sequence of a caution region registration process according to the first embodiment. This caution region registration process is performed after the primary defect position information is generated in the manufacturing stage. Here, in the following explanation, it is assumed that registration of a caution region is performed if a primary defect is continued 100 or more tracks. Further, it is assumed that a caution region is set to correspond to each of the groups of ±10 tracks respectively from the opposite ends of the primary defect.

At first, when the control section 28 receives an instruction of a caution region registration process (S11), it selects one of the records in the primary defect position information inside the nonvolatile memory 25 (S12) The control section 28 determines whether the primary defect of the selected record is continued 100 or more tracks (S13). If the selected record is continued 100 or more tracks (Yes in S13), the control section 28 designates a portion corresponding to each of the groups of ±10 tracks respectively from the opposite ends of the selected record as a caution region, and registers it into the caution region address information (S14).

Thereafter, or if the selected record is not continued 100 or more tracks in S13 (No in S13), the control section 28 determines whether another record is present in the primary defect position information (S15). If another record is present (Yes in S15), the process sequence returns to S12 so that the control section 28 will process all the records in the primary defect position information. On the other hand, if another record is not present (No in S15), the process sequence ends.

<Reading Process>

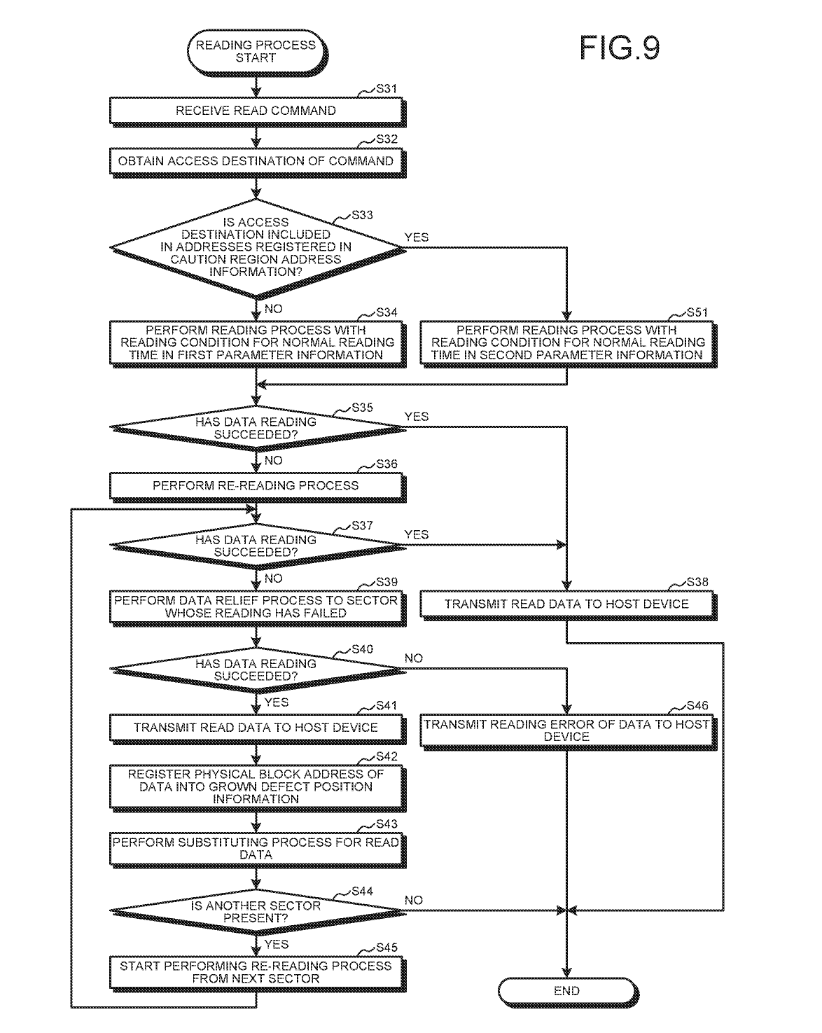

FIG. 9 is a flow chart showing an example of a sequence of a reading process according to the first embodiment. At first, when the control section 28 receives a read command from the host device 40 (S31), it obtains the access destination of the received command (S32), and determines whether the access destination is included in the addresses registered in the caution region address information (S33).

If the access destination of the read command is not included in the addresses in the caution region address information (No in S33), the control section 28 performs a reading process with the reading condition for the normal reading time in the first parameter information (S34). Then, the control section 28 determines whether the data reading from the magnetic disk 11 has succeeded as a result of the reading process (S35). If the data reading has succeeded (Yes in S35), the HDC 23 transmits the read data to the host device 40 (S38), and the process sequence ends.

On the other hand, if the data reading has failed (No in S35), the control section 28 performs a re-reading process (S36), and then determines whether the data reading has succeeded (S37). The reading process at this time is performed to one or more sectors as the reading targets. If the data reading has succeeded (Yes in S37), the HDC 23 transmits the read data to the host device 40 (S38), and the process sequence ends.

The re-reading process of S36 is arranged to select a reading condition from the reading conditions belonging to the first group of the first parameter information, in a sequential manner from the first priority, and to perform a retry reading process by use of the selected reading condition. As described above, this reading process is a process of performing data re-reading, based on the premise that the signal quality obtained by reading stored data is not in a state deteriorated to a degree at which it is difficult to read the signal. If data reading succeeds before or when a retry reading process using the reading condition of the m-th priority is performed, the result thus obtained is transmitted to the host device 40. However, if data reading fails even by a reading process using the reading condition of the m-th priority, the process sequence moves to the subsequent process step.

In S37, if the data reading has failed (No in S37), the control section 28 performs a data relief process (S39), and then re-determines whether the data reading has succeeded (S40). The data relief process of S39 is performed to a sector whose reading has failed by the re-reading process of S36. If the data reading has succeeded (Yes in S40), the HDC 23 transmits the read data to the host device 40 (S41). Further, the control section 28 registers the physical recording position of this data into the grown defect position information (S42), and performs the substituting process for the read data (S43).

Thereafter, the control section 28 determines whether another sector whose reading process has not yet been performed is present, in relation to the reading target data (S44). If another sector is present (Yes in S44), the control section 28 starts performing a re-reading process, from the sector next to the sector whose data relief process has been performed in S39 (S45). This re-reading process is the same as the re-reading process of S36. On the other hand, in S44, if another sector is not present (No in S44), the process sequence ends.

Specifically, the data relief process of S39 is arranged to select a reading condition from the reading conditions belonging to the second group of the first parameter information, in a sequential manner from the first priority, and to perform a retry reading process by use of the selected reading condition. As described above, this reading process is a process of performing data reading, based on the premise that the signal quality obtained by reading stored data is in a state deteriorated to a degree at which it is difficult to read the signal. If data reading succeeds before or when a retry reading process using the reading condition of the n-th priority is performed, the HDC 23 transmits the result thus obtained to the host device 40. Further, the physical recording position of this data is registered into the grown defect position information. Furthermore, the substituting process is performed to write the read data into a substitution region. In this substituting process, a record is registered into the address conversion information, such that the record correlates the logical block address and physical block address, at which a grown defect has been generated, with the physical block address of the substitution destination.

However, in S40, if the data reading has failed even by a retry reading process using the reading condition of the n-th priority (No in S40), it is concluded that the data cannot be read. Thus, a reading error of the data is transmitted to the host device 40 (S46), and the process sequence ends.

On the other hand, in S33, if the access destination of the read command is included in the addresses in the caution region address information (Yes in S33), the control section 28 performs a reading process with the parameter for the normal reading time in the second parameter information (S51). Thereafter, the processes of from S35 to S44 are performed. However, in each of S36 and S45, a re-reading process is performed by use of the reading conditions included in the first group of the second parameter information, and, in S39, a data relief process is performed by use of the reading conditions included in the second group of the second parameter information.

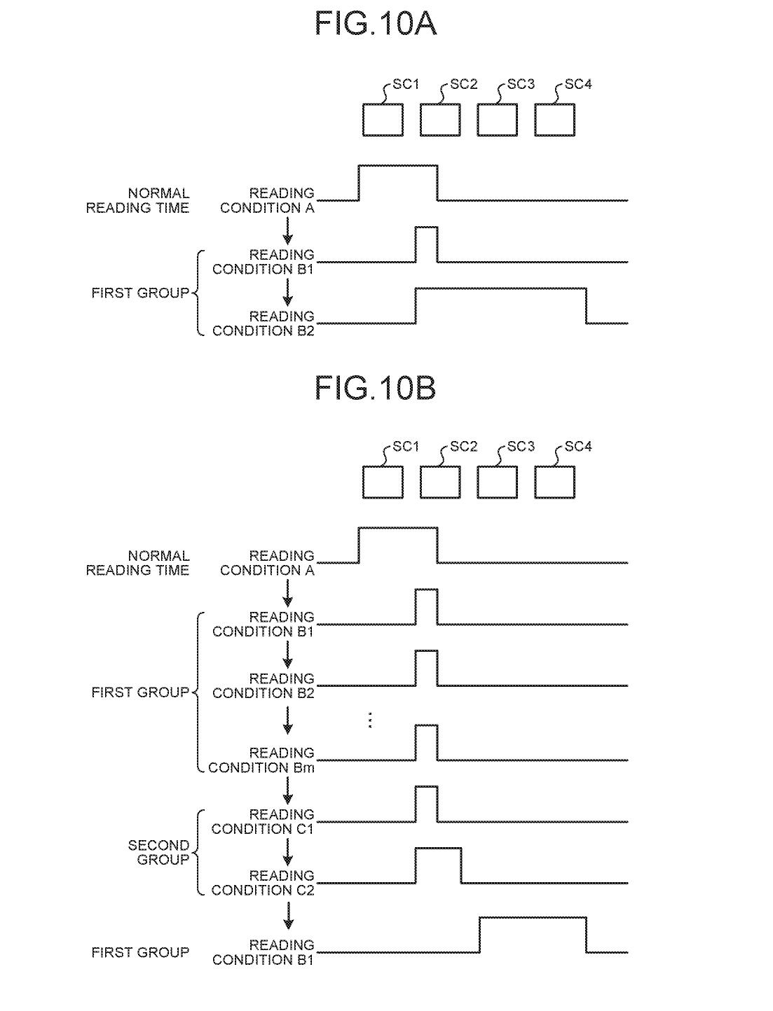

Next, an explanation will be given of an example of the re-reading process and an example of the data relief process. FIGS. 10A and 10B are views respectively showing examples of the re-reading process and the data relief process. Here, the explanation is exemplified by a case that the host device 40 issues a command of reading a normal region of sectors SC1 to SC4. Further, in the timing charts shown in FIGS. 10A and 10B, a rising portion denotes the start of reading, and a falling portion denotes the end of processing without success in reading.

In the normal reading time, a reading process is performed by use of the reading condition A selected from the first parameter information shown in FIG. 3. As shown in FIG. 10A, it is assumed that the reading process using the reading condition A succeeds in reading of the sector SC1 and fails in reading of the sector SC2. In this case, a re-reading process is performed by use the reading conditions in the first group of the first parameter information shown in FIG. 3. At first, a retry reading process is performed by use of the reading condition B1 of the first priority, and is assumed to fail in reading. Then, a retry reading process is performed by use of the reading condition B2 of the second priority, and is assumed to succeed in reading of all the sectors SC2 to SC4. Accordingly, the data thus read from the sectors SC1 to SC4 is transmitted to the host device 40. Further, since the reading has succeeded by use of the first group, the grown defect registration is not performed for the sector SC2 whose reading has failed by use of each of the reading conditions A and B1.

On the other hand, as shown in FIG. 10B, it is assumed that the reading process using the reading condition A succeeds in reading of the sector SC1 and fails in reading of the sector SC2. In this case, a re-reading process is performed by use of the reading conditions in the first group of the first parameter information shown in FIG. 3. At first, a retry reading process is performed by use of the reading condition B1 of the first priority, and is assumed to fail in reading. Thereafter, reading is performed sequentially by use of the reading conditions B2 of the second priority to Bm of the m-th priority, and is assumed to fail in reading of the sector SC2.

In this case, a data relief process is performed by use of the reading conditions in the second group of the first parameter information. At first, a retry reading process is performed by use of the reading condition C1 of the first priority, and is assumed to fail in reading. Thereafter, a retry reading process is performed by use of the reading condition C2 of the second priority, and is assumed to succeed in reading of the sector SC2.

Thereafter, for the next sector SC3, a re-reading process is performed by use of the parameter in the first group of the first parameter information. Here, it is assumed that reading of each of the remaining sectors SC3 and SC4 succeeds by a retry reading process using the reading condition B1 of the first priority.

In this case, the grown defect registration is performed for the sector SC2 whose retry reading process has been performed by use of the reading conditions in the second group. Further, a reading process using each of the reading conditions in the first group is arranged to perform reading to a plurality of sectors, and a reading process using each of the reading conditions in the second group is arranged to perform reading to a single sector. Here, if reading fails at a sector by the reading conditions in the first group, reading is performed to this sector by use of the reading conditions in the second group, but reading is performed to a subsequent sector or sectors by use of the reading conditions in the first group. In this way, the process sequence moves back and forth between the re-reading process and the data relief process, as the case may be.

Here, the explanation described above is exemplified by a case that a caution region is set if a primary defect continuous through 100 or more tracks is present, but this is mere example. Further, a caution region may be set based on the length of a medium flaw that causes a primary defect.

Further, the explanation described above is exemplified by a case that the size of a caution region is set to correspond to 10 tracks, but this is mere example. The size of a caution region is set in consideration of an estimated growth degree of a medium flaw that causes a primary defect, during an estimated use period in which the magnetic disk device 10 is used by a user. Further, even for medium flaws having the same size, the number of tracks for defining a caution region may differ depending on the dimension of the track width. For example, if the track width is larger, the number of tracks of a caution region decreases, and, if the track width is smaller, the number of tracks of a caution region increases.

Further, for example, the size of a caution region may be set in accordance with the size of a primary defect. For example, if a primary defect has a size of not less than 30 tracks but less than 100 tracks, a caution region may be set to have a size of each of the groups of ±5 tracks, and, if a primary defect has a size of 100 or more tracks, a caution region may be set to have a size of each of the groups of ±10 tracks.

The data of a normal region has a low possibility of making data reading impossible due to growth of a medium flaw in the near future, but the data of a caution region has a high possibility of making data reading impossible due to progress of a medium flaw in the near future. Accordingly, in the first embodiment, the data of a caution region is treated by the data relief process with a higher weight than the re-reading process, such that the data whose re-reading has failed by the re-reading process is positively regarded as a grown defect, and the substituting process is performed to store data read by the data relief process into another physical position. Consequently, it is possible to save the data of a caution region into a substitution region at an earlier time before data reading becomes impossible. As a result, it is possible to improve the long term reliability of the magnetic disk device 10.

### Second Embodiment

In the first embodiment, if a primary defect continuous through a predetermined number or more number of tracks is present, a region corresponding to a predetermined number of tracks adjacent to this primary defect is set as a caution region. However, there may be a case that a magnetic disk device suffers a grown defect generated in a use stage after its shipment. A medium flaw seems to be one of the causes of a grown defect of this kind. In this case, the grown defect may grow and make data reading impossible around the grown defect. Accordingly, the second embodiment will take as an example a case that a caution region is set when a grown defect is registered, as well.

A magnetic disk device according to the second embodiment has the same configuration as the magnetic disk device 10 described in the first embodiment. However, the control section 28 includes a function of registering a predetermined region adjacent to a grown defect, as a caution region, if the grown defect is found or registered. For example, as in the first embodiment, a caution region is set to correspond to each of the groups of ±10 tracks respectively from the opposite ends of the grown defect. Here, unlike the case of a primary defect, a caution region is set with respect to every grown defect, regardless of the size of a grown defect.

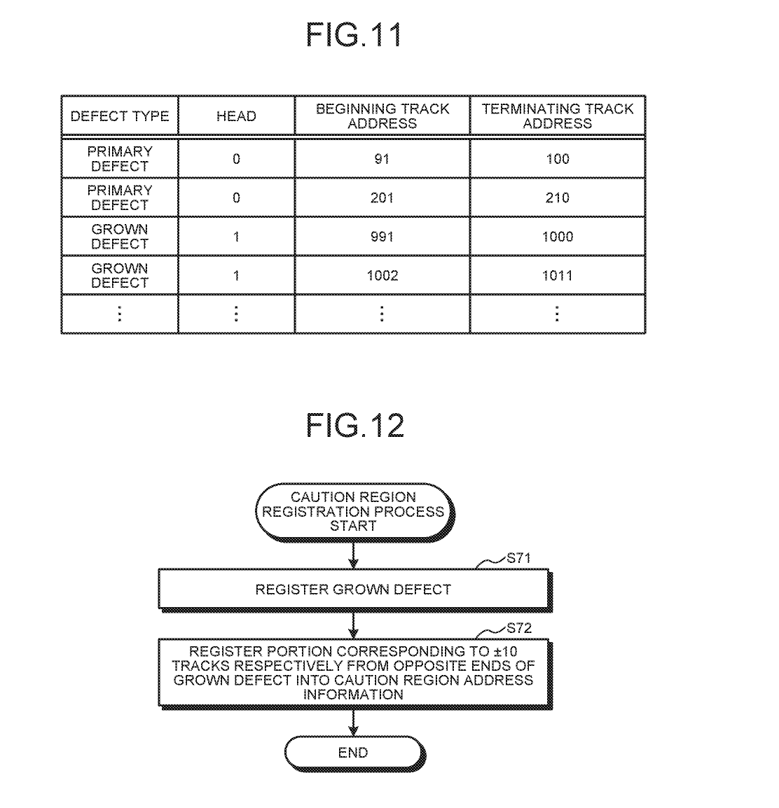

Further, in the caution region address information, not only caution regions associated with primary defects, but also caution regions associated with grown defects are stored. FIG. 11 is a view showing an example of the caution region address information according to the second embodiment. In the caution region address information shown in FIG. 6, only primary defects are recorded, but, in the caution region address information shown in FIG. 11, grown defects are recorded in addition to primary defects. Here, the other components are the same as those of the first embodiment, and so their description will be omitted.

Next, an explanation will be given of a caution region registration process according to the second embodiment. FIG. 12 is a flow chart showing an example of a sequence of a caution region registration process according to the second embodiment. At first, when a grown defect is registered into the grown defect position information (S71), the control section 28 registers a portion corresponding to each of the groups of ±10 tracks respectively from the opposite ends of the grown defect into the caution region address information (S72). Then, the process sequence ends.

Here, the reading process is the same as that described in the first embodiment, and so its description will be omitted.

The second embodiment can provide the same effect as that first embodiment.

Here, the explanation described above is exemplified by a case that a read command is received from the host device 40, but the embodiments are not limited to this example. For example, the above described process sequence may be used for reading during a refresh process, in which magnetically deteriorated magnetic data is read from the corresponding track and then the magnetic data thus read is written again into this track.

Further, the explanation described above is exemplified by a case that the primary defect position information and the first parameter information are stored in the nonvolatile memory 25, but they may be stored in the magnetic disk 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk that is provided with a recording surface and stores data, the recording surface including a defect region including a defect portion on the recording surface, a first region adjacent to the defect region and having a particular width, and a second region adjacent to the first region and present as a region other than the defect region; and
a controller configured to perform writing of data into the magnetic disk and reading of data from the magnetic disk, wherein
the controller is configured to
perform, when an access destination of a reading request is the second region, a reading process by use of a first reading condition for a normal reading in first parameter information, and perform, if reading of data fails, a first retry reading process by use of a second reading condition, which is a setting condition for retry reading, in the first parameter information, the first parameter information including the first reading condition and a plurality of different second reading conditions,
perform, when the access destination of the reading request is the first region, a reading process by use of a third reading condition for a normal reading in second parameter information, and perform, if reading of data fails, a second retry reading process by use of a fourth reading condition, which is a setting condition for retry reading, in the second parameter information, the second parameter information including the third reading condition and a plurality of different fourth reading conditions,
register, if reading of the data fails in the first retry reading process even by performing retry reading a first number of times, a writing position of the data in the second region as a grown defect, and
register, if reading of the data fails in the second retry reading process even by performing retry reading a second number of times, a writing position of the data in the first region as a grown defect, and
the second parameter information is set such that the grown defect is registered at an earlier time in the second retry reading process, as compared with that in the first retry reading process.

2. The magnetic disk device according to claim 1, wherein the second number of times is smaller than the first number of times.

3. The magnetic disk device according to claim 1, wherein the magnetic disk further includes a first storage part that stores address information indicating a position of the first region, and
the controller is configured to determine, based on the address information stored in the first storage part, whether the access destination of the reading request is in the first region.

4. The magnetic disk device according to claim 3, wherein the defect portion comprises a primary defect that is generated on the magnetic disk in a manufacturing stage of the magnetic disk device and continuous through a first number or more number of tracks.

5. The magnetic disk device according to claim 4, wherein the address information includes information about a region corresponding to a second number of tracks from a beginning track address of the primary defect, and about a region corresponding to the second number of tracks from a terminating track address of the primary defect.

6. The magnetic disk device according to claim 5, wherein the second number of tracks corresponds to a length of growth of a continuous medium flaw estimated during an estimated use period of the magnetic disk device.

7. The magnetic disk device according to claim 3, wherein the defect portion comprises a grown defect generated on the magnetic disk in a use stage of the magnetic disk device.

8. The magnetic disk device according to claim 7, wherein the address information includes information about a region corresponding to a second number of tracks from a beginning track address of the grown defect, and about a region corresponding to the second number of tracks from a terminating track address of the grown defect.

9. The magnetic disk device according to claim 1, wherein the controller is configured to register at least a physical address of the data as the grown defect into grown defect position information, and write the data read by the retry reading into a substitution region.

10. The magnetic disk device according to claim 1, wherein the plurality of second reading conditions are categorized into a first group and a second group, the first group including setting conditions, in a number corresponding to the first number of times, based on a premise that the data whose reading has failed by use of the first reading condition is not deteriorated in signal quality, and the second group including a setting condition based on a premise that the data is deteriorated in signal quality, and
the plurality of fourth reading conditions are categorized into a third group and a fourth group, the third group including setting conditions, in a number corresponding to the second number of times, based on a premise that the data whose reading has failed by use of the third reading condition is not deteriorated in signal quality, and the fourth group including a setting condition based on a premise that the data is deteriorated in signal quality.

11. The magnetic disk device according to claim 10, wherein the number of the setting conditions in the third group is smaller than the number of the setting conditions in the first group, and
the number of the setting conditions in the fourth group is larger than the number of the setting conditions in the second group.

12. The magnetic disk device according to claim 1, wherein the number of the fourth reading conditions is larger than the number of the second reading conditions.

13. The magnetic disk device according to claim 1, wherein the reading request includes a read command received from a host device, or a reading request for a refresh process that written data is re-written.

14. A method of reading data stored in a recording surface of a magnetic disk in a magnetic disk device, the recording surface including a defect region including a defect portion on the recording surface, a first region adjacent to the defect region and having a particular width, and a second region adjacent to the first region and present as a region other than the defect region, the method comprising:
determining whether an access destination of a reading request is the second region;
performing, when the access destination of the reading request is the second region, a first reading process by use of a reading condition in first parameter information; and
performing, when the access destination of the reading request is the first region, a second reading process by use of a reading condition in second parameter information, wherein
the first reading process includes
performing a reading process by use of a first reading condition for a normal reading in the first parameter information, the first parameter information including the first reading condition and a plurality of different second reading conditions, and
performing, if reading of data fails, a first retry reading process by use of a second reading condition, which is a setting condition for retry reading, in the first parameter information, and
the second reading process includes
performing a reading process by use of a third reading condition for a normal reading in the second parameter information, the second parameter information including the third reading condition and a plurality of different fourth reading conditions, and
performing, if reading of data fails, a second retry reading process by use of a fourth reading condition, which is a setting condition for retry reading, in the second parameter information,
the method further comprising:
registering, if reading of the data fails in the first retry reading process even by performing retry reading a first number of times, a writing position of the data in the second region as a grown defect, and
registering, if reading of the data fails in the second retry reading process even by performing retry reading a second number of times, a writing position of the data in the first region as a grown defect,
wherein the second parameter information is set such that the grown defect is registered at an earlier time in the second retry reading process, as compared with that in the first retry reading process.

15. The method according to claim 14, wherein the second number of times is smaller than the first number of times.

16. The method according to claim 14, wherein the determinating of the access destination of the reading request comprises determining whether the access destination of the reading request is in the first region based on address information, the address information including a position of the first region recorded therein.

17. The method according to claim 16, wherein the defect portion comprises a primary defect that is generated on the magnetic disk in a manufacturing stage of the magnetic disk device and continuous through a first number or more number of tracks.

18. The method according to claim 17, wherein the address information includes information about a region corresponding to a second number of tracks from a beginning track address of the primary defect, and about a region corresponding to the second number of tracks from a terminating track address of the primary defect.

19. The method according to claim 18, wherein the second number of tracks corresponds to a length of growth of a continuous medium flaw estimated during an estimated use period of the magnetic disk device.

20. The method according to claim 16, wherein the defect portion comprises a grown defect generated on the magnetic disk in a use stage of the magnetic disk device.
